(19) United States
(12) Patent Application Publication
(10) Pub. No.: US 2022/0338192 A1
(43) Pub. Date: Oct. 20, 2022

(54) RADIO COMMUNICATION NODE

(71) Applicant: NTT DOCOMO, INC., Tokyo (JP)

(72) Inventors: Daisuke Kurita, Tokyo (JP); Hiroki Harada, Tokyo (JP); Weiqi Sun, Beijing (CN); Jing Wang, Beijing (CN); Xiaolin Hou, Beijing (CN)

(73) Assignee: NTT DOCOMO, INC., Tokyo (JP)

(21) Appl. No.: 17/763,141

(22) PCT Filed: Sep. 26, 2019
(86) PCT No.: PCT/JP2019/037950

§ 371 Date: Mar. 23, 2022

(51) Int. Cl. H04W 72/04; H04W 72/02

(52) U.S. Cl. CPC H04W 72/0433; H04W 72/0446; H04W 72/0453; H04W 72/02

(57) ABSTRACT

A radio communication node is disclosed including a higher node connecting unit used for a connection with a higher node; a lower node connecting unit used for a connection with a lower node; and a control unit that gives a notification indicating a direction of downlink or uplink in which a radio resource destined for the lower node is used to the higher node or a network.

### TECHNICAL FIELD

The present invention relates to a radio communication node that sets up radio access and radio backhaul.

### BACKGROUND ART

In the 3rd Generation Partnership Project (3GPP), Long Term Evolution (LTE) has been specified, and LTE-Advanced (hereinafter referred to as LTE including LTE-Advanced) and 5G New Radio (NR) or successor systems of LTE called Next Generation (NG) or the like have been specified.

For example, in a radio access network (RAN) of NR, integrated access and backhaul (IAB) in which radio access to a user equipment (UE) and radio backhaul between radio communication nodes such as radio base stations (gNBs) are integrated is under reviewed (see Non Patent Literature 1).

In IAB, an IAB node includes s mobile termination (MT) which is a function of establishing a connection with a parent node and a distributed unit (DU) which is a function of establishing a connection with a child node or a UE.

In Release 16 of 3GPP, the radio access and the radio backhaul are on the basis of half-duplex communication and time division multiplexing (TDM). As radio resources available by the radio access and the radio backhaul, downlink (DL), uplink (UL), and Flexible time-resources (D/U/F) are classified into any one type of hard, soft, and Not Available (H/S/NA) from the point of view of the DU.

Specifically, “hard” is a radio resource in which a corresponding time resource is always available for a DU child link connected to a child node or a UE, and “soft” is a radio resource (DU resource) in which whether or not a corresponding time resource is available for a DU child link is explicitly or implicitly controlled by a parent node.

Therefore, any one of DL-H, DL-S, UL-H, UL-S, F-H, F-S or NA is set as the DU resource.

### CITATION LIST

### Non Patent Literature

Non Patent Literature 1: 3GPP TR 38.874 V16.0.0, 3rd Generation Partnership Project; Technical Specification Group Radio Access Network; NR; Study on Integrated Access and Backhaul; (Release 16), 3GPP, December, 2018

### SUMMARY OF INVENTION

As described above, in Release 16 of 3GPP, it is assumed that TDM is used, simultaneous operation of the MT and the DU of the IAB node is not considered. From Release 17 onwards, application of space division multiplexing (SDM) and frequency division multiplexing (FDM) is under review.

In specifications after Release 17, it is necessary to consider the simultaneous operation of the MT and the DU while following the IAB function of Release 16.

In particular, in a case in which the DU resource is Flexible, specifically F-H or F-S, the parent node may not be able to always correctly recognize whether or not the DU resource of Flexible is used in DL or UL of the IAB node.

In this regard, the present invention was made in light of the foregoing, and it is an object of the present invention to provide a radio communication node that enables the parent node and the IAB node to more reliably support the simultaneous operation of the MT and the DU following the default IAB function.

One aspect of the present disclosure is a radio communication node (a radio communication node 100B) including a higher node connecting unit (a higher node connecting unit 170) used for a connection with a higher node, a lower node connecting unit (a lower node connecting unit 180) used for a connection with a lower node, and a control unit (a control unit 190) that gives a notification indicating a direction of downlink or uplink in which a radio resource destined for the lower node is used to the higher node or a network.

### BRIEF DESCRIPTION OF DRAWINGS

FIG. 1 is an overall configuration diagram of a radio communication system 10.

FIG. 2 is a diagram illustrating a basic configuration example of IAB.

FIG. 3 is a functional block configuration diagram of a radio communication node 100A.

FIG. 4 is a functional block configuration diagram of a radio communication node 100B.

FIG. 5 is a diagram illustrating a schematic communication sequence when radio communication using SDM/FDM is executed in an architecture of IAB.

FIG. 6 is a diagram illustrating a notification image to a parent node in a direction of an F-H DU resource by an IAB node.

FIG. 7 is a diagram illustrating a configuration example of CSI-ReportConfig IE according to an operation example 1-1.

FIG. 8 is a diagram illustrating a configuration example of a transmission direction report of a plurality of DU hard-F slots (symbols).

FIG. 9 is a diagram illustrating a configuration example of a transmission direction report of a DU hard-F slot (symbol) according to an operation example 1-2-1.

FIG. 10 is a diagram illustrating a configuration example of a transmission direction report according to an operation example 1-3-2.

FIG. 11 is a diagram illustrating a configuration example of CSI-ReportConfig IE according to an operation example 3-1.

FIG. 12 is a diagram illustrating an example of a transmission direction report of F-S according to an operation example 3-2-1.

FIG. 13 is a diagram illustrating an example of a transmission direction report of F-S according to an operation example 3-2-2.

FIG. 14 is a diagram illustrating an example of a transmission direction report of F-S according to an operation example 3-2-3.

FIG. 15 is a diagram illustrating an example of a hardware configuration of each of a CU 50 and radio communication nodes 100A to 100C.

### DESCRIPTION OF EMBODIMENTS

Hereinafter, an exemplary embodiment will be described with reference to the appended drawings. Note that the same functions or configurations are denoted by the same or similar reference numerals, and description thereof will be omitted as appropriate.

### (1) Overall Schematic Configuration of Radio Communication System

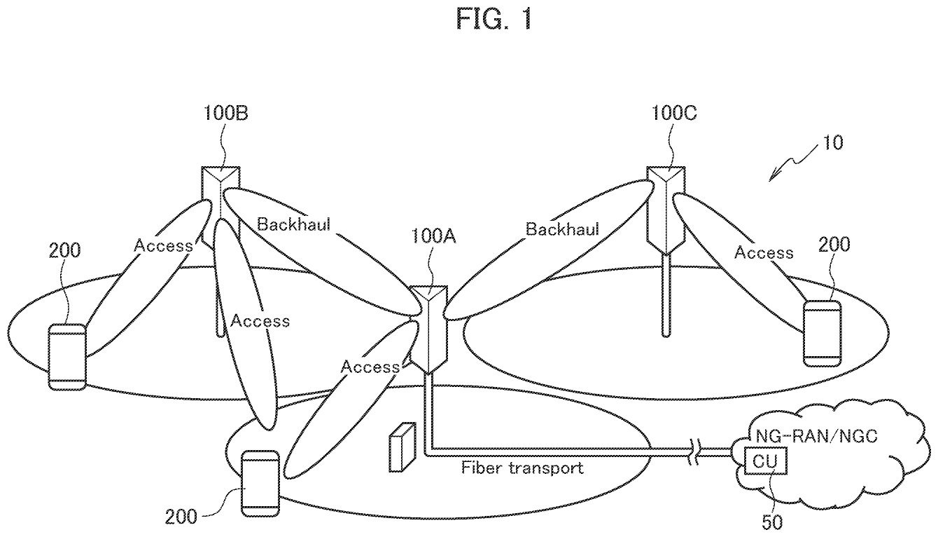

FIG. 1 is an overall configuration diagram of a radio communication system 10 according to the present embodiment. The radio communication system 10 is a radio communication system that complies with 5G New Radio (NR) and includes a plurality of radio communication nodes and a user equipment.

Specifically, the radio communication system 10 includes radio communication nodes 100A, 100B, and 100C and a user equipment 200 (hereinafter, the UE 200).

The radio communication nodes 100A, 100B, and 100C can set radio access with the UE 200 and radio backhaul (BH) between the radio communication nodes. Specifically, a backhaul (transmission path) by a radio link is set between the radio communication node 100A and the radio communication node 100B and between the radio communication node 100A and the radio communication node 100C.

As described above, the configuration in which the radio access with the UE 200 and the radio backhaul between the radio communication nodes are integrated is called integrated access and backhaul (IAB).

In IAB, the existing functions and interfaces defined for radio access are reused. In particular, interfaces corresponding to a mobile-termination (MT), a gNB-DU (distributed Unit), a gNB-CU (central unit), a user plane function (UPF), an access and mobility management function (AMF), and a session management function (SMF) such as NR Uu (between the MT and the gNB/DU), F1, NG, X2, and N4 are used as a base line.

The radio communication node 100A is connected to a radio access network (NG-RAN) and a core network (next generation core (NGC) or 5GC) of NR via a wired transmission path such as a fiber transport. The NG-RAN/NGC includes a central unit 50 (hereafter, a CU 50) which is a communication node. Further, NG-RAN and NGC may be simply referred to as a “network.”

The CU 50 may be configured with any of the UPF, the AMF, the SMF, and a combination thereof. Alternatively, the CU 50 may be a gNB-CU as described above.

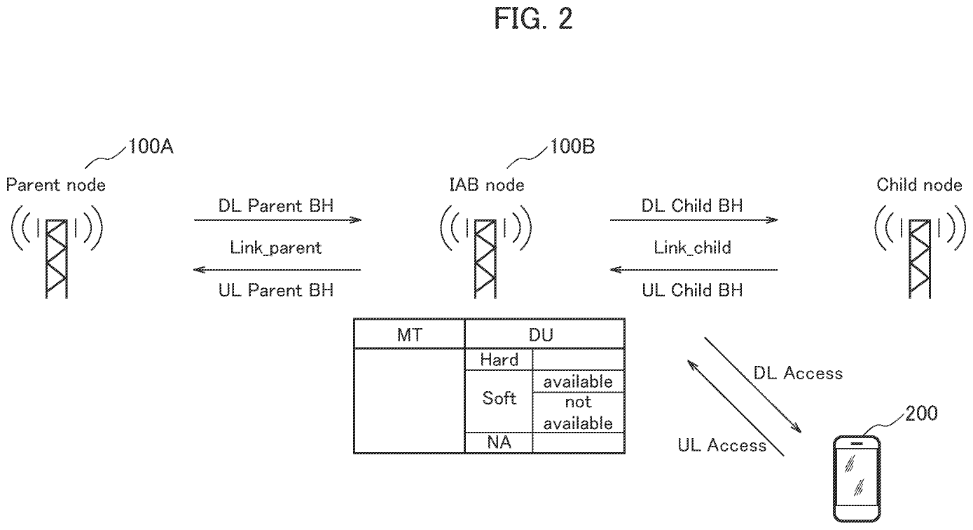

FIG. 2 illustrates a basic configuration example of IAB. As illustrated in FIG. 2, in the present embodiment, the radio communication node 100A constitutes a parent node (Parent node) in IAB, and the radio communication node 100B (and the radio communication node 100C) constitutes an IAB node in IAB. The parent node is also called an IAB donor.

The child node in IAB is configured with other radio communication nodes not illustrated in FIG. 1. Alternatively, the UE 200 may constitute the child node.

A radio link is configured between the parent node and the IAB node. Specifically, a radio link called Link_parent is configured.

The radio link is configured between the IAB node and the child node. Specifically, a radio link called Link_child is configured.

Such a radio link set between radio communication nodes is called a radio backhaul link. Link_parent is configured with DL Parent BH in the downlink direction and UL Parent BH in the uplink direction. Link_child is configured with DL Child BH in the downlink direction and UL Child BH in the uplink direction.

The radio link configured between the UE 200 and the IAB node or the parent node is called a radio access link. Specifically, the radio link is configured with DL Access in the downlink direction and UL Access in the uplink direction.

The IAB node includes a mobile termination (MT) which is a function for establishing a connection with the parent node and a distributed unit (DU), which is a function for establishing a connection with the child node (or the UE 200). Although not illustrated in FIG. 2, the parent node and the child node include the MT and the DU as well.

As the radio resources used by the DU, downlink (DL), uplink (UL), and Flexible time-resource (D/U/F) are classified into any one type of hard, soft, and Not Available (H/S/NA) from the point of view of the DU. Also, available (available) or unavailable (not available) is specified even within soft (S).

Note that the configuration example of IAB illustrated in FIG. 2 uses CU/DU division, but the IAB configuration is not necessarily limited to such a configuration. For example, IAB may be configured by tunneling using GPRS Tunneling Protocol (GTP)-U/User Datagram Protocol (UDP)/Internet Protocol (IP) for the radio backhaul.

The main advantage of IAB is that cells of NR can be flexibly and densely arranged without densifying the transport network. IAB can be applied to various scenarios such as outdoor or indoor small cell arrangement and mobile relay (for example, in buses or trains).

Also, as illustrated in FIG. 1 and FIG. 2, IAB may support deployment by only stand-alone (SA) of NR or deployment by non-stand-alone (NSA) including other RAT (LTE or the like).

In the present embodiment, the radio access and the radio backhaul operate on the premise of half-duplex communication. However, the present embodiment is not necessarily limited to half-duplex communication, and full-duplex communication may be used as long as the requirements are satisfied.

Further, time division multiplexing (TDM), space division multiplexing (SDM), and frequency division multiplexing (FDM) can be used as a multiplexing scheme.

In a case in which the IAB node operates according to half-duplex, the DL Parent BH serves as a receiving (RX) side, the UL Parent BH serves as a transmitting (TX) side, the DL Child BH serves as a transmitting (TX) side, the UL Child BH serves as a receiving (RX) side. Further, in the case of time division duplex (TDD), a configuration pattern of DL/UL in the IAB node is not limited to DL-F-UL only, and configuration patterns such as radio backhaul (BH) and UL-F-DL may be applied.

In the present embodiment, simultaneous operation of the DU and the MT of the IAB node is implemented using SDM/FDM.

### (2) Functional Block Configuration of Radio Communication System

Next, functional block configurations of the radio communication node 100A and the radio communication node 100B that constitute the radio communication system 10 will be described.

### (2.1) Radio Communication Node 100A

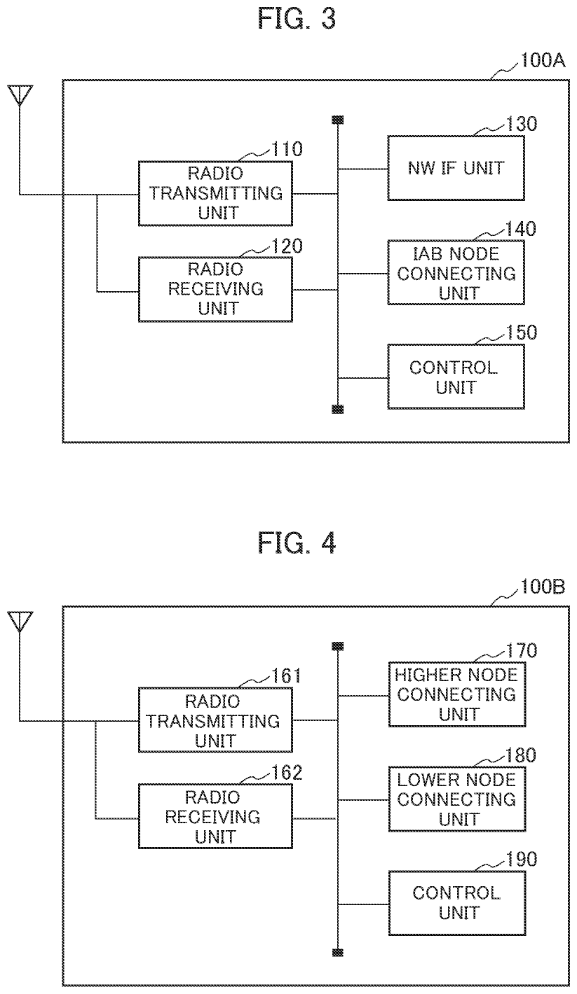

FIG. 3 is a functional block configuration diagram of the radio communication node 100A that constitutes the parent node. As illustrated in FIG. 3, the radio communication node 100A includes a radio transmitting unit 110, a radio receiving unit 120, an NW IF unit 130, an IAB node connecting unit 140, and a control unit 150.

The radio transmitting unit 110 transmits radio signals according to the 5G specifications. Also, the radio receiving unit 120 transmits radio signals according to the 5G specifications. In the present embodiment, the radio transmitting unit 110 and the radio receiving unit 120 execute radio communication with the radio communication node 100B that constitutes the IAB node.

In the present embodiment, the radio communication node 100A has functions of the MT and the DU, and the radio transmitting unit 110 and radio receiving unit 120 also transmit and receive radio signals corresponding to MT/DU.

The NW IF unit 130 provides a communication interface for implementing a connection with the NGC side or the like. For example, the NW IF unit 130 may include an interface such as X2, Xn, N2, or N3.

The IAB node connecting unit 140 provides an interface for implementing a connection with the IAB node (or the child node including the UE). Specifically, the IAB node connecting unit 140 provides the function of the distributed unit (DU). In other words, the IAB node connecting unit 140 is used for a connection with the IAB node (or the child node).

The IAB node may be expressed as a RAN node that supports radio access to the UE 200 and wirelessly backhauls an access traffic. Further, the parent node, that is, the IAB donor, may be expressed as the RAN node that provides the UE interface to the core network and the radio backhaul function to the IAB node.

The control unit 150 controls the respective functional blocks that constitute the radio communication node 100A. Particularly, in the present embodiment, the control unit 150 acquires configurations of the radio resources destined for the child node in the IAB node.

Specifically, the control unit 150 can acquire a transmission direction in which the DU resource of the IAB node is used, that is, a notification indicating a direction of DL or UL in which the DU resource is used from the IAB node. Alternatively, the control unit 150 can acquire a notification indicating a direction of DL or UL in which the DU resource is used from the network, specifically, the CU 50.

Also, the control unit 150 may schedule the radio resource in accordance with a default operation which can be applied in a case in which it fails to receive the notification in a case in which it fails to receive the notification indicating a direction of DL or UL in which the DU resource is used. The default operation will be described later.

### (2.2) Radio Communication Node 100B

FIG. 4 is a functional block configuration diagram of the radio communication node 100B that constitutes the IAB node. As illustrated in FIG. 4, the radio communication node 100B includes a radio transmitting unit 161, a radio receiving unit 162, a higher node connecting unit 170, a lower node connecting unit 180, and a control unit 190.

As described above, the radio communication node 100B includes the functional blocks similar to those of the radio communication node 100A (the parent node) described above but differs in that the higher node connecting unit 170 and the lower node connecting unit 180 are disposed, and the function of the control unit 190 is different.

The radio transmitting unit 161 transmits radio signals according to the 5G specifications. Also, the radio receiving unit 162 transmits radio signals according to the 5G specifications. In the present embodiment, the radio transmitting unit 161 and the radio receiving unit 162 executes radio communication with the radio communication node 100A that constitutes the parent node and executes radio communication with the child node (including the case of the UE 200).

The higher node connecting unit 170 provides an interface or the like for implementing a connection with a node higher than the IAB node. The higher node means a radio communication node located on a network side higher than the IAB node, more specifically, the core network side (which may be called an upstream side or an uplink side).

Specifically, the higher node connecting unit 170 provides the function of the mobile termination (MT). In other words, in the present embodiment, the higher node connecting unit 170 is used for establishing a connection with the parent node that constitutes the higher node.

The lower node connecting unit 180 provides an interface or the like for implementing a connection with lower nodes than the IAB node. The lower node means a radio communication node located on an end user side (which may be called a downstream side or a downlink side) of the IAB node.

Specifically, the lower node connecting unit 180 provides the function of the distributed unit (DU). In other words, in the present embodiment, the lower node connecting unit 180 is used for establishing a connection the child node (which may be the UE 200) that constitutes the lower node.

The control unit 190 controls the respective functional blocks that constitute the radio communication node 100B. In particular, in the present embodiment, the control unit 190 gives a notification indicating a direction of DL or UL in which the radio resource (the DU resource) destined for the lower node is used to the higher node or the network.

As described above, the DU resource can be defined as Flexible (F) that can be used for both DL and UL.

As described above, the control unit 190 can give a notification indicating the direction in which the radio resource is used for the radio resource (flexible) which is used in both DL or UL in the lower node, that is, the child node to the parent node (the radio communication node 100A) or the CU 50. A flexible hard (hereinafter appropriately referred to as F-H) resource and a flexible soft (hereinafter appropriately referred to as F-S) resource are used as the radio resource (the DU resource).

The control unit 190 can give a notification indicating the direction in which the radio resource is used by using uplink control information, specifically, Uplink Control Information (UCI). The UCI is transmitted via a predetermined channel.

Control channels and a data channels are included in channels. The control channels include a physical downlink control channel (PDCCH), a physical uplink control channel (PUCCH), a physical random access channel (PRACH), and a physical broadcast channel (PBCH).

The data channels include a physical downlink shared channel (PDSCH) and a physical uplink shared channel (PUSCH).

Further, reference signals include a demodulation reference signal (DMRS), a sounding reference signal (SRS), a phase tracking reference signal (PTRS), and a channel state information-reference signal (CSI-RS), and the channels and the reference signals are included as signals. Also, data may mean data transmitted via the data channel.

The UCI is control information which is symmetric to downlink control information (DCI) and is transmitted via a PUCCH or a PUSCH. The UCI may include a scheduling request (SR), a hybrid automatic repeat request (HARQ) ACK/NACK, and a channel quality indicator (CQI).

The control unit 190 may give the notification indicating the direction in which the radio resource is used using signaling of a medium access control-control element (MAC-CE), or a upper layer (a radio resource control layer (RRC) or the like).

The control unit 190 can determine a slot which is a notification target in accordance with an interval at which the notification indicating the direction in which the radio resource is used is given.

For example, in a case in which the control unit 190 is configured such that the notification is sent in a particular slot n (which may be called a symbol), the notification may include information indicating a direction in which slots n to slots n+k are used. Note that the slot n+k may be synchronized with a timing of the next notification.

The control unit 190 may determine a radio resource which is a notification target on the basis of whether or not the radio resource is available. Specifically, in a case in which the radio resource is soft (S), the control unit 190 can determine the radio resource which is a notification target on the basis of whether or not it is IA or INA.

“IA” means that the DU resource is explicitly or implicitly indicated as being available. “INA” means explicitly or implicitly indicating that the DU resource is explicitly or implicitly indicated as unavailable. A specific notification example will be described later.

Further, the control unit 190 may give the notification indicating the used direction for each frequency or each cell.

Specifically, the control unit 190 can give the notification indicating the direction in which the radio resource is used for each used frequency (which may be a component carrier) or each serving cell, particularly, when the carrier aggregation (CA) is used (dual connectivity (DC) may be included).

### (3) Operation of Radio Communication System

Next, an operation of the radio communication system 10 will be explained. Specifically, the simultaneous operation of the DU and the MT of the IAB node will be explained. More specifically, efficient coordination of the used radio resource between the parent node and the IAB node while realizing the simultaneous operation of the DU and the MT of the IAB node using SDM or FDM will be described.

### (3.1) General Operation

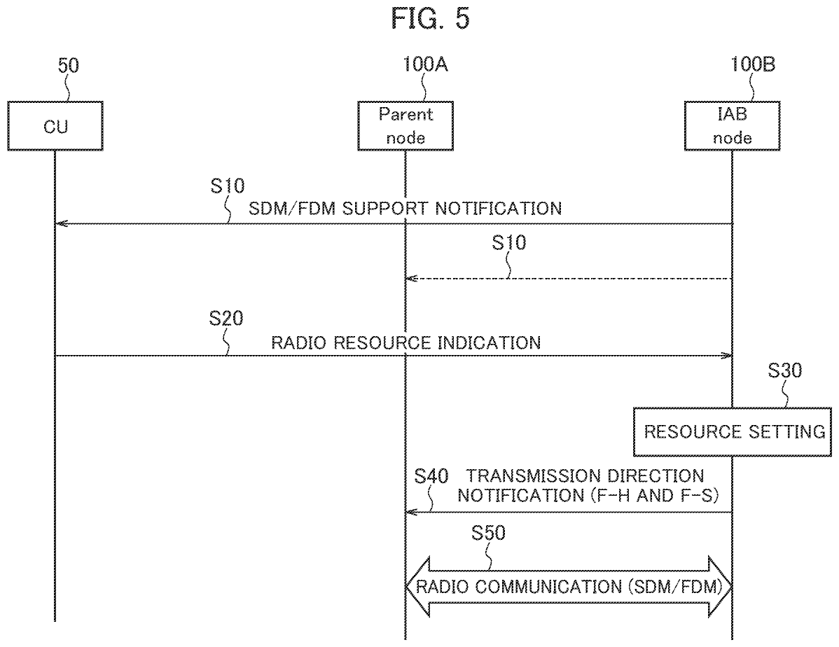

FIG. 5 illustrates a schematic communication sequence in a case in which radio communication is executed using SDM/FDM in the architecture of IAB.

As illustrated in FIG. 5, the IAB node (the radio communication node 100B) transmits an SDM/FDM support notification indicating whether or not its own node supports SDM/FDM to the network, specifically, to the CU 50 (S10).

The IAB node may transmits the SDM/FDM support notification to the parent node (radio communication node 100A) (see a dotted line in FIG. 5).

The CU 50 gives an indication of the radio resource which can be used by the DU of the IAB node to the IAB node on the basis of content of the SDM/FDM support notification received from the IAB node, an allocation status of the radio resource to other radio communication nodes constituting IAB, or the like (S20).

The IAB node sets the radio resource used by the DU and the MT of the IAB node on the basis of content of the received radio resource indication (S30). The settings of the radio resource include settings of the multiplexing scheme (SDM/FDM).

Further, the IAB node gives the notification indicating the direction (the transmission direction) of DL or UL in which the radio resource (the DU resource) destined for the lower node (the child node) is used to the parent node (S40). Specifically, in the case of the flexible hard (F-H) resource and the flexible soft (F-S) resource, the IAB node gives the notification indicating the transmission direction to the parent node.

The IAB node executes radio communication according to SDM/FDM with the parent node and the child node (including the UE) not illustrated in FIG. 5 on the basis of the settings of the radio resource (S50).

### (3.2) Detailed Operation

Next, the above-described operation will be described in detail. First, in Release 16 of 3GPP, the MT and the DU are under review mainly on the assumption that TDM is used. Therefore, the simultaneous operation of the MT and the DU is not considered in the specification study, and the following operations are agreed.
The CU sets downlink (DL), uplink (UL), and Flexible time-resources (D/U/F) for the MT and the DU of the IAB node.
The CU sets hard, soft, or Not Available (H/S/NA) for the resource of the DU of the IAB node.

Therefore, the DU resource of the IAB node is set to any of DL-H, DL-S, UL-H, UL-S, F-H, F-S, and NA.
The parent node indicates the availability for the soft DU resource of the IAB node.
The parent node has a function of detecting all or part of the settings (H/S/NA/D/U/F) of the DU resource of the IAB node.

In the present embodiment, the simultaneous operation of the MT and the DU of the IAB node using SDM/FDM is implemented while following the specifications of Release 16.

In the present embodiment, the following assumptions 0 to 4 are set, and proposals 0 to 5 corresponding to the assumptions are presented. The respective assumptions and the proposals 0 to 5 have the following relations.
Assumption 0: A case in which the DU resource is NA (Not Available),
(Proposal 0): In a case in which the transmission/reception (Tx/Rx) directions of the DU and the MT coincide with each other, the DU is able to perform data transmission/reception (that is, executes data transmission/reception) even when NA is indicated.
Assumption 1: A case in which the DU resource is DL-H or UL-H
(Proposal 1): It is reported to the CU whether or not the IAB node support SDM/FDM (it may be notified as the capability of the IAB node).
(Proposal 2): The CU gives an indication of D/U/F and H/S/NA to the DU similarly to Release 16 in addition to as indication of whether or not the IAB node supports SDM/FDM.
(Proposal 3): In a case in which the transmission/reception (Tx/Rx) directions of the DU and the MT coincide with each other or do not coincide with each other, the Tx/Rx direction of the MT is caused to coincide with that of the DU so that the data transmission/reception by the MT can be performed.
Assumption 2: A case in which the DU resource is DL-S or UL-S,

In order to notify of IA/INA for DL-S and UL-S, the parent node conforms to “Assumption 1” for IA and “Assumption 0” for INA.

“IA” means that the DU resource is explicitly or implicitly indicated as being usable. “INA” means explicitly or implicitly indicating that the DU resource is explicitly or implicitly indicated as unavailable.
Assumption 3: A case in which the DU resource is F-H
(Proposal 4): A case in which the DU resource is F-H, the parent node has a function of recognizing which of transmission and reception the DU of the IAB node which is dynamically instructed is used for.
(Proposal 5): It conforms to “Proposal 3” when the configuration pattern in the DU of the IAB node is DL/UL, and transmission and reception by the MT are disabled when it is F.
Assumption 4: A case in which the DU resource is F-S

The parent node or the IAB node configures D/U/F for F, and the parent node notifies IA/INA for S. For this reason, it conforms to “Assumption 1” in the case of DL-IA or UL-IA, it conforms to “Assumption 3” in the case of F-IA, and it conforms to “Assumption 0” in the case of DL-INA, UL-INA, or F-INA.

The following description will proceed with specific operations of the IAB node and the parent node in a case in which SDM/FDM is supported in DU hard-F (F-H) under Assumption 3 and in a case in which SDM/FDM is supported in DU soft-F (F-S) in Assumption 4.

### (3.3) Operation Examples

An operation example in which the IAB node gives a notification indicating the transmission direction in which the Flexible resource (F-H or F-S) of the DU is used (which may be simply called a direction), specifically, a notification indicating any one of DL or UL to the parent node will be described below.

If the support of SDM/FDM is considered, the flexible resource (F-H or F-S) of the DU has the following conditions.

(Condition 1): In the case of SDM/FDM, the simultaneous transmission/reception of the DU and the MT in the case of F-H (hereinafter, simultaneous Tx/Rx) is executed in accordance with the direction of the DU.
In F-H, the MT can execute Tx only when the DU is Tx and the parent node DU recognizes that the DU is Tx in advance. The MT can execute Rx only when the DU is Rx and the parent node DU recognizes that the DU is Rx in advance.
In F-S, simultaneous Tx/Rx is unable to be executed or can be executed in accordance with the MT direction.

(Condition 2): In the case of SDM/FDM, simultaneous Tx/Rx is supported by following the direction of the DU in both F-S and F-H indicated as the IA resource.
In F-S and F-H indicated as the IA resource, the MT can execute Tx only when the DU is Tx and the parent node DU recognizes that the DU is Tx in advance. The MT can execute Rx only when the DU is Rx and the parent node DU recognizes that the DU is Rx in advance.

In other words, the condition 1 is a case in which the DU resource is F-H, and the condition 2 is a case in which the DU resource is F-H or F-S (in the case of Available).

The following operation examples will be described for each condition.

(Condition 1: A case in which the DU resource is F-H)
(Operation example 1) A notification indicating the direction (DL/UL) of the DU resource of the IAB node using the UCI
(Operation example 1-1) A notification indicating the F-H direction (DL/UL) of the DU given to the parent node.
(Operation example 1-2) A notification indicating the F-H direction of the DU for the slots n to n+k is given.
(Operation example 1-3) An individual and/or simultaneous notification indicating the F-H direction of the DU of each frequency in carrier aggregation (CA).
(Operation example 1-4) Operation according to the default configuration when the notification indicating the F-H direction of the DU fails.
(Operation example 2) A notification indicating the direction (DL/UL) of the DU resource given by the IAB node using the MAC CE or the upper layer.

The notification content in the operation example 2 may conform to the operation examples 1-1 to 1-4.

(Condition 2: The DU resource is F-H or F-S (when Available))
(Operation example 3) A notification indicating the direction (DL/UL) of the DU resource given by the IAB node using the UCI.
(Operation example 3-1) A notification indicating the direction (DL/UL) of F-H or F-S of the DU given to the parent node.
(Operation example 3-2) A notification indicating the direction of F-H or F-S of the DU for the slots n to n+k.

There may be three patterns of notification content according to availability (IA/INA) of F-S (only IA of F-S/all/other than INA).
(Operation example 4) A notification indicating the direction (DL/UL) of the DU resource given by the IAB node using the MAC CE or the upper layer.

### (3.3.1) Condition 1

As described above, in F-H, in a case in which the parent node recognizes the direction in which the DU resource is used, simultaneous Tx/Rx of the DU and the MT can be executed. It is necessary for the IAB node to report the direction of the DU resource of F-H to the parent node via signaling of the UL.

The signaling of the UL may be any one of UCI, MAC-CE, the upper layer as described above.

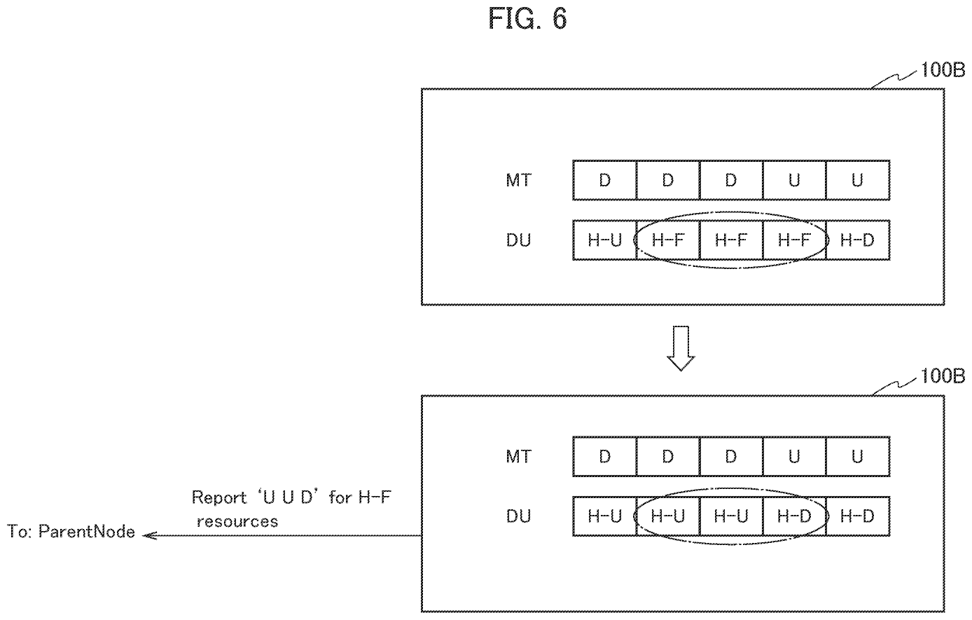

FIG. 6 illustrates a notification image of the direction of the F-H DU resource given from the IAB node to the parent node. As illustrated in FIG. 6, the IAB node (the radio communication node 100B) determines the direction of DL or UL in which the hard resource of Flexible (which is denoted as “H-F” in FIG. 6 (hereinafter the same) but is the same definition as “F-H”) among the DU and MT resources of its own node.

FIG. 6 illustrates an example in which the IAB node determines to use three (slots) F-Hs (in a dashed-dotted frame in FIG. 6) in UL, UL, and DL (H-U, H-U, and H-D).

The IAB node reports, to the parent node, information indicating an F-H determination result, that is, UL, UL, or DL (‘U D’ in FIG. 6).

The content reported (notified) from the IAB node to the parent node may indicate either DL or UL explicitly or may indicate only one of them. Alternatively, it may be associated with a value such as an arbitrary integer, and the value may be notified of.

Further, not only the transmission direction of the Flexible resource but also all D/U/F resources, that is, DL(D) and UL(U) may be notified of.

### (3.3.1.1) Operation Example 1-1

In the present operation example, the frame work of the channel state information (CSI) is reused for the report of the transmission direction of F-H.

Specifically, the transmission direction of F-H can be included in the CSI-Report. The transmission direction of F-H may support periodic, semi-persistent, and aperiodic reports.

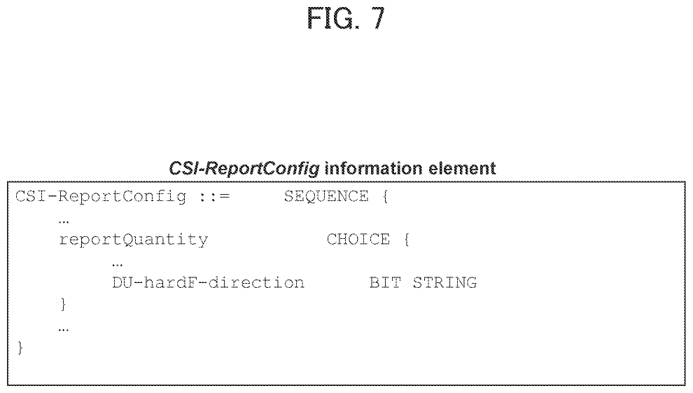

FIG. 7 illustrates a configuration example of CSI-ReportConfig IE according to the operation example 1-1. As illustrated in FIG. 7, CSI-ReportConfig IE can include DU-hard F-direction used for reporting (notifying of) the transmission direction of F-H. DU-hardF-direction can be expressed as a bit string. DU-hard F-direction may have any other name as long as it indicates the transmission direction of F-H.

### (3.3.1.2) Operation Example 1-2

For example, in a case in which the report of the transmission direction of F-H is configured to be transmitted in a slot n and is triggered, the report can be configured as the information indicating the transmission direction of the DU hard-F symbols of a plurality of slots (symbols) of the slots n to n+k.

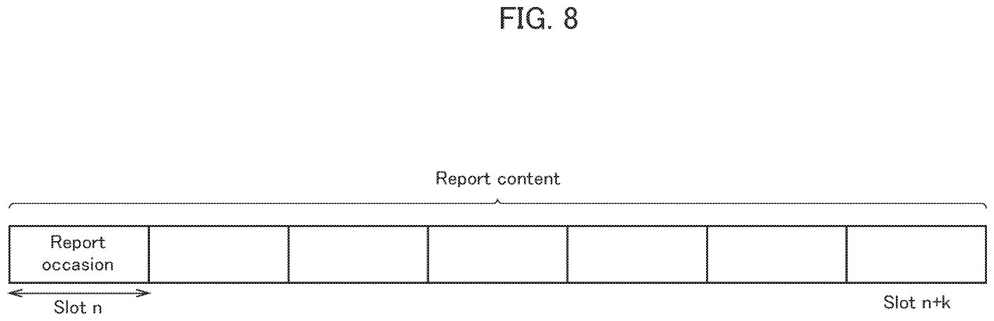

FIG. 8 illustrates a configuration example of a transmission direction report of a plurality of DU hard-F slots (symbols). As illustrated in FIG. 8, the transmission direction report includes information indicating the transmission direction of F-H of a plurality of slots of the slots n to n+k serving as a report occasion.

D/U or D/U/F can be reported for each symbol. Also, the value of k may be determined as follows.
(Operation example 1-2-1): k is determined in accordance with a pre-defined value or a pre-defined rule.

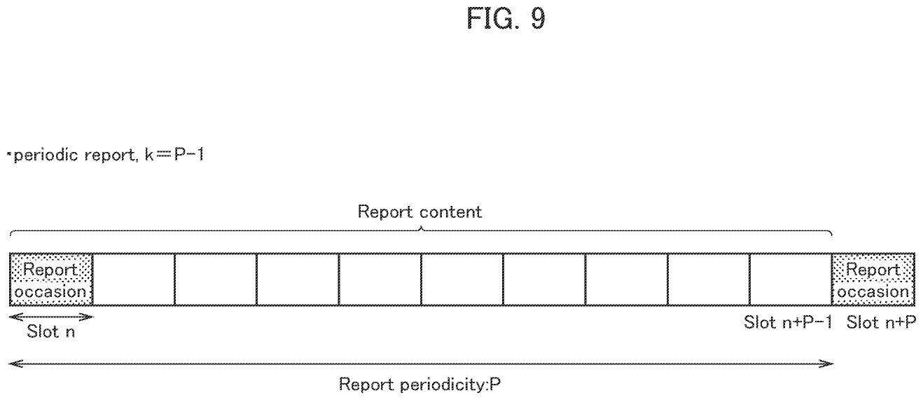

FIG. 9 illustrates a configuration example of a transmission direction report of the DU hard-F slot (symbol) according to the operation example 1-2-1. Specifically, FIG. 9 illustrates an example of a transmission direction report that is transmitted periodically, and k=P−1 can be determined.
(Operation example 1-2-2): k is set by RRC signaling.

However, RRC need not be necessarily used, and signaling of other layers (MAC or the like) may be used.

### (3.3.1.3) Operation Example 1-3

In the present operation example, carrier aggregation (CA) is considered. The same may apply to dual connectivity (DC). Specifically, the following operations are specified.
(Operation example 1-3-1): The transmission direction report of F-H of each serving cell is transmitted individually. In this case, the index of the serving cell is included in the transmission direction report. The content of the transmission direction report of each serving cell may follow the operation example 1-2.
(Operation example 1-3-2): The transmission direction reports of F-H of a plurality of serving cells are transmitted through one UCI. The index of the serving cell in the UCI and information indicating the position of the report of the serving cell are included in the transmission direction report. The content of the transmission direction report of each serving cell may follow the operation example 1-2.

The serving cells may include a primary cell (PCell), SpCell (PCell and PSCell), and the like

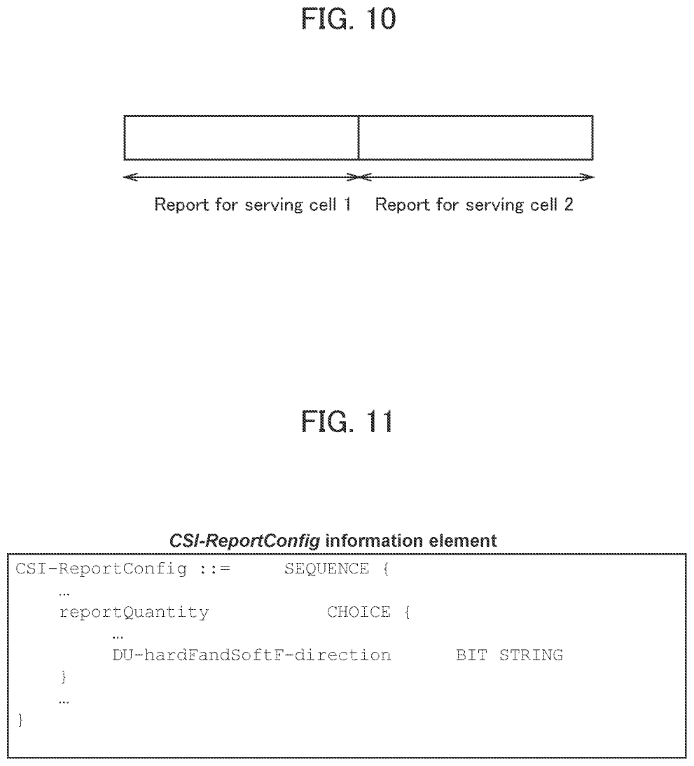

FIG. 10 illustrates a configuration example of the transmission direction report according to the operation example 1-3-2. As illustrated in FIG. 10, the transmission direction report is intended for a plurality of (two) serving cells and can include the transmission direction report of F-H of each serving cell.

### (3.3.1.4) Operation Example 1-4

In the present operation example, the operation according to the default configuration of the parent node is specified in a case in which the parent node does not (is unable to) receive the transmission direction report of F-H from the IAB node. Specifically, the following operations are specified.
(Operation example 1-4-1): The parent node is unable to (does not) schedule F-H to the MT
(Operation example 1-4-2): The parent node can schedule DL to the MT of the IAB node (the child node). In other words, the default configuration is based on SDM/FDM between DL Rx of Link_parent and UL Rx of Link_child/UL Access.
(Operation example 1-4-3): The parent node can schedule UL to the MT of the child node. In other words, the default configuration is based on SDM/FDM between UL Tx of Link_parent and DL Tx of Link_child/DL Access.
(Operation example 1-4-4): The operation according to the default configuration (the operation example 1-4-1, 1-4-2, or 1-4-3) is determined on the basis of the configuration provided by the CU 50 or the parent node.
(Operation example 1-4-5): The operation according to the default configuration (the operation example 1-4-1, 1-4-2 or 1-4-3) is determined on the basis of the reported function of the IAB node (the child node).

### (3.3.1.5) Operation Example 2

In the present operation example, the transmission direction report of F-H is transmitted via signaling of the MAC CE or the upper layer. In the present operation example, similarly to the operation example 1, the periodic, semi-persistent, or aperiodic report may be supported.

Similarly to the operation example 1-2 and the operation example 1-3, signaling of the MAC CE or the upper layer may include the information indicating the transmission direction of the DU hard-F symbol of a plurality of slots (symbols) of the slots n to n+k and can report D/U or D/U/F for each symbol. Furthermore, in the case of CA (including DC), the transmission direction of F-H in each serving cell may be notified individually or simultaneously.

In a case in which the parent node does not (is unable to) receive the transmission direction report of F-H from the IAB node, the operation according to the default configuration of the parent node may be identical to that in the operation example 1-4.

### (3.3.2) Condition 2

As described above, in the condition 2, in F-H and F-S indicated as the IA resources, simultaneous Tx/Rx of the DU and the MT can be executed in a case in which the parent node recognizes the transmission direction of the DU resource. It is necessary for the IAB node to report the transmission direction of F-H and F-S to the parent node via UL signaling.

The UL signaling can be implemented by the UCI, the MAC CE, or the upper layer.

Hereinafter, the resource of the UL signaling for reporting the transmission direction of F-H and F-S and the content of the UL signaling for reporting the transmission direction of F-H and F-S are specified.

### (3.3.2.1) Operation Example 3-1

In the present operation example, as in the operation example 1-1, the frame work of the CSI is reused for the transmission direction report of F-H.

Specifically, the transmission directions of F-H and F-S can be included in the CSI-Report. The transmission direction of F-H and F-S may support the periodic, semi-persistent, or aperiodic report.

FIG. 11 illustrates a configuration example of CSI-ReportConfig IE related to the operation example 3-1. As illustrated in FIG. 11, CSI-ReportConfig IE can include DU-hardFandSoftF-direction used for reporting (notifying of) the transmission directions of F-H and F-S. DU-hardFandSoftF-direction can be expressed as a bit string. DU-hardFandSoftF-direction may have another name as long as it indicates the transmission direction of F-H and F-S.

### (3.3.2.2) Operation Example 3-2

Similarly to the operation example 1-2, in a case in which the report of the transmission direction of F-H or F-S is configured to be transmitted by the slot n and is triggered, the report can be configured as the information indicating the transmission direction of the DU hard-F symbols of a plurality of slots (symbols) of the slots n to n+k.

Also, D/U or D/U/F can be reported for each symbol. The value of k may be determined similarly to the operation examples 1-2-1 and 1-2-2.

Furthermore, if the availability of F-S is considered, it may operate as follows.
(Operation example 3-2-1): The IAB node reports (notifies of) only the transmission direction of F-S indicated as IA until the occasion of the transmission direction report.
(Operation example 3-2-2): The IAB node reports (notifies of) the transmission direction of all F-S regardless of the availability indication.
(Operation example 3-2-3): The IAB node reports (notifies of) the transmission directions of all F-Ss except F-S indicated as INA until the occasion of the transmission direction report.

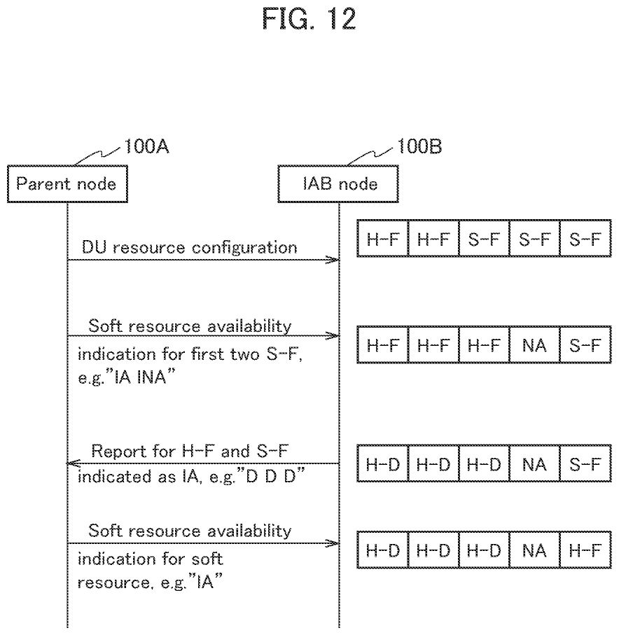

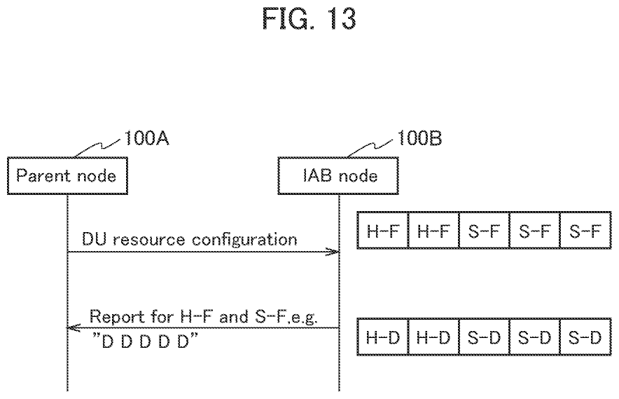

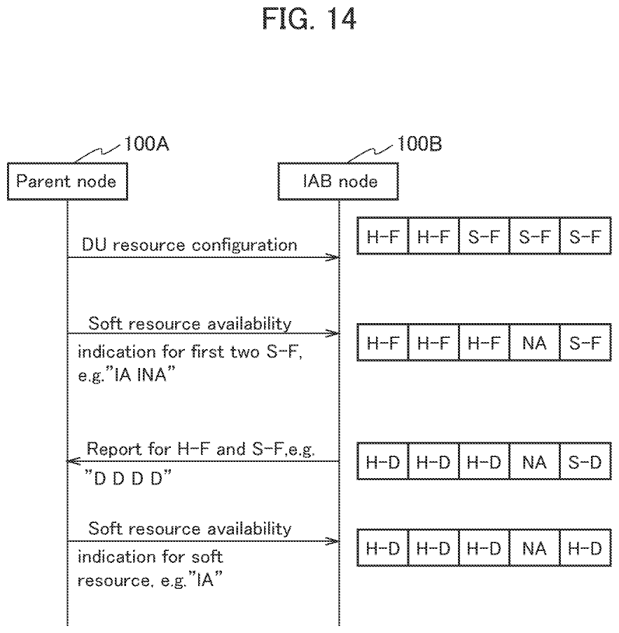

FIG. 12 illustrates an example of the transmission direction report of F-S according to the operation example 3-2-1. FIG. 13 illustrates an example of the transmission direction report of F-S according to the operation example 3-2-2. FIG. 14 illustrates an example of the transmission direction report of F-S according to the operation example 3-2-3.

As illustrated in FIG. 12, in the operation example 3-2-1, in order to support the simultaneous Tx/Rx of the DU and the MT, it is necessary for the IAB node (the radio communication node 100B) to acquire the availability of F-S (indicated as S-F in FIG. 12) before the occasion of the transmission direction report). Otherwise, the IAB node does not report the transmission direction of F-S, and the simultaneous Tx/Rx using F-S is unable to be executed. As illustrated in FIG. 12, the IAB node does not report the transmission direction of last F-S (the right side in FIG. 12), and the simultaneous Tx/Rx using that F-S is unable to be executed.

As illustrated in FIG. 13, in the operation example 3-2-2, the IAB node reports the transmission direction of all F-Ss regardless of the availability of F-S. The transmission direction report and the availability indication can be regarded as independent procedures. The transmission direction report can be regarded as a resource request, and the simultaneous Tx/Rx can be executed for each resource. Accordingly, the resource usage rate is improved compared to the operation example 3-2-1. On the other hand, the overhead related to signaling is larger than in the operation example 3-2-1.

As illustrated in FIG. 14, in the operation example 3-2-3, the IAB node reports the transmission direction of all F-Ss except F-S indicated as INA. Accordingly, the overhead can be further reduced compared to the operation example 3-2-2.

### (3.3.2.3) Operation Example 3-3

Similarly to the operation example 1-3, the carrier aggregation (CA) is considered in the present operation example. Specifically, the following operations are specified.
(Operation example 3-3-1): The transmission direction reports of F-H and F-S of the respective serving cells are transmitted individually. In this case, the index of the serving cell is included in the transmission direction report. The content of the transmission direction report of each serving cell may follow the operation example 3-2.
(Operation example 3-3-2): The transmission direction reports of F-H and F-S of a plurality of serving cells are transmitted by one UCI. The index of the serving cell in the UCI and information indicating the position of the report of the serving cell are included in the transmission direction report. The content of the transmission direction report of each serving cell may follow the operation example 3-2.

Also, the transmission direction report according to the present operation example may have a configuration similar to that of the operation example 1-3-2 illustrated in FIG. 10.

### (3.3.2.4) Operation Example 3-4

In the present operation example, the operation according to the default configuration of the parent node is specified in a case in which the parent node does not (is unable to) receive the transmission direction report of F-H and F-S from the IAB node. Such an operation is similar to that in the operation example 1-4 except that F-S is included. Specifically, the following operations are specified.
(Operation example 3-4-1): The parent node is unable to (does not) schedule F-H and F-S to the MT
(Operation example 3-4-2): The parent node can schedule DL to the MT of the IAB node (the child node). In other words, the default configuration is based on SDM/FDM between DL Rx of Link_parent and UL Rx of Link_child/UL Access.
(Operation example 3-4-3): The parent node can schedule UL to the MT of the child node. In other words, the default configuration is based on SDM/FDM between UL Tx of Link_parent and DL Tx of Link_child/DL Access.
(Operation example 3-4-4): The operation according to the default configuration (the operation example 3-4-1, 3-4-2, or 3-4-3) is determined on the basis of the configuration provided by the CU 50 or the parent node.
(Operation example 3-4-5): The operation according to the default configuration (the operation example 3-4-1, 3-4-2 or 3-4-3) is determined on the basis of the reported function of the IAB node (the child node).

### (3.3.2.5) Operation Example 4

Similarly to the operation example 2, in the present operation example, the transmission direction report of F-H and F-S is transmitted via signaling of the MAC CE or the upper layer. In the present operation example, similarly to the operation example 3, the periodic, semi-persistent, or aperiodic report may be supported.

Similarly to the operation example 3-2 and the operation example 3-3, signaling of the MAC CE or the upper layer may include the information indicating the transmission directions of the DU hard-F symbol and the soft-F symbol of a plurality of slots (symbols) of the slots n to n+k and can report D/U or D/U/F for each symbol. Furthermore, in the case of CA (including DC), the transmission directions of F-H and F-S in each serving cell may be notified of individually or simultaneously.

In a case in which the parent node does not (is unable to) receive the transmission direction report of F-H and F-S from the IAB node, the operation according to the default configuration of the parent node may be similar to that in the operation example 3-4.

### (4) Operational Effects

According to the above embodiment, the following operational effects can be obtained. Specifically, the IAB node (the radio communication node 100B) according to the present embodiment gives the notification indicating the direction of DL or UL in which the radio resource (the DU resource) destined for the lower node (the child node) is used to the higher node (the parent node) or the network.

Therefore, in particular, even when the DU resource is Flexible, specifically, F-H or F-S, the parent node can correctly recognize which of DL and UL of the IAB node the DU resource of the Flexible is used in. Accordingly, the parent node and the IAB node can more reliably support the simultaneous operation of the MT and the DU while following the default IAB function.

In the present embodiment, the IAB node can give the notification, to the higher node or the network, indicating the direction in which the radio resource is used for the radio resource, specifically, for F-H or F-S which is used in both DL and UL in the lower node. Therefore, for the Flexible resource that can be used in both DL and UL, the parent node can correctly recognize which of DL and UL of the IAB node the DU resource of Flexible is used. Accordingly, the parent node and the IAB node can more reliably support the simultaneous operation of the MT and the DU while following the default IAB function.

In the present embodiment, the IAB node can determine the slot (symbol) that is the notification target in accordance with the interval to notify of the direction in which the radio resource (F-H or F-S) destined for the lower node is used. Accordingly, the transmission direction of F-H or F-S can be efficiently reported to the parent node.

In the present embodiment, the IAB node can determine the radio resource which is the notification target on the basis of the availability (IA, INA) of the radio resource (F-S) destined for the lower node. Accordingly, the transmission direction of F-S can be reported to the parent node by the optimal method in which the signaling overhead is considered.

In the present embodiment, the IAB node can give the notification indicating the direction in which the radio resource destined (F-H or F-S) for the lower node is used for each frequency or each cell, particularly, in a case in which the carrier aggregation (CA) is used (the dual connectivity (DC) may be included). Accordingly, even when the CA is applied to the IAB configuration, the transmission direction of F-H or F-S can be accurately reported to the parent node.

### (5) Other Embodiments

Although the content of the present invention has been described above with reference to the embodiment, it is obvious to those skilled in the art that the present invention is not limited to the above description, and various modifications and improvements can be made.

For example, in the above-described embodiment, the names such as the parent node, the IAB node, and the child node are used, but different names may be used as long as the radio communication node in which the radio backhaul between the radio communication nodes such as gNBs and the radio access with the user equipment are integrated is employed. For example, they may be simply called first and second nodes or may be called higher nodes, lower nodes, relay nodes, intermediate nodes, or the like.

Also, the radio communication node may be simply called a communication device or communication node or may be interpreted interchangeably with a radio base station.

In the above embodiment, the terms downlink (DL) and uplink (UL) are used, but they may be called by other terms. For example, it may be replaced with or associated with terms such as forward link, reverse link, access link, or backhaul. Alternatively, terms such as 1st link, 2nd link, 1st direction, 2nd direction, or the like may simply be used.

Further, the block configuration diagrams (FIGS. 3 and 4) used to describe the embodiment described above indicate blocks of function units. Those functional blocks (structural components) can be realized by a desired combination of at least one of hardware and software. A realization method of each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

The functions include determining, deciding, judging, computing, calculating, processing, deriving, investigating, searching, confirming, receiving, transmitting, outputting, accessing, resolving, selecting, choosing, establishing, comparing, assuming, expectation, regarding, broadcasting, notifying, communicating, forwarding, configuring, reconfiguring, allocating, mapping, assigning, and the like but are not limited thereto. For example, a functional block (structural component) that causes transmitting may be called a transmitting unit or a transmitter. For any of the above, as explained above, the realization method is not particularly limited to any one method.

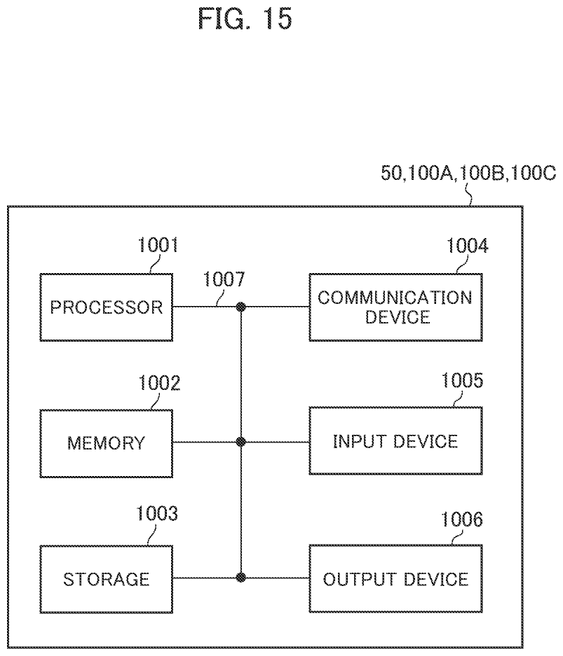

Further, the CU 50 and the radio communication nodes 100A to 100C (the devices) described above may function as a computer that performs processing of the radio communication method of the present disclosure. FIG. 15 is a diagram illustrating an example of a hardware configuration of the device. As illustrated in FIG. 15, the device may be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices illustrated in the figure, or can be constituted by without including a part of the devices.

Each functional block of the device (see FIGS. 3 and 4) is realized by any hardware element of the computer device or a combination of the hardware elements.

Moreover, the processor 1001 performs computing by loading a predetermined software (computer program) on hardware such as the processor 1001 and the memory 1002, and realizes various functions of the device by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (computer program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main memory), and the like. The memory 1002 can store therein a computer program (computer program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information thereamong. The bus 1007 may be configured by using a single bus or may be configured by using a different bus between devices.

Further, the device may be configured to include hardware such as a microprocessor, a digital signal processor (DSP), an application specific integrated circuit (ASIC), a programmable logic device (PLD), or a field programmable gate array (FPGA) or all or some of the functional blocks may be implemented by hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, notification information (Master Information Block (MIB), System Information Block (SIB)), other signals, or a combination of these. The RRC signaling may be called RRC message, for example, or can be RRC Connection Setup message, RRC Connection Reconfiguration message, or the like.

Each aspect and embodiment of the present invention may be applied to at least one of Long Term Evolution (LTE), LTE-advanced (LTE-A), SUPER 3G, IMT-advanced, 4th generation mobile communication system (4G), 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), a system using any other appropriate system, a next generation systems extended on the basis of these standards, or the like. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information and signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, computer program code, computer program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type). At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station.

A radio frame may include one or more frames in the time domain. In the time domain, each of one or more frames may be called a sub frame.

The sub frame may further include one or more slots in the time domain. The sub frame may have a fixed time length (for example, 1 ms) not depending on numerology.

The numerology may be a communication parameter applied to at least one of transmission and reception of a certain signal or channel. For example, the numerology may indicate at least one of a subcarrier spacing (SCS), a bandwidth, a symbol length, a cyclic prefix length, a transmission time interval (TTI), a number of symbols per TTI, a radio frame configuration, a specific filtering processing performed in the frequency region by a transceiver, a specific windowing processing performed in the time domain by a transceiver, and the like.

The slot may include one or more symbols (orthogonal frequency division multiplexing (OFDM) symbols, single carrier frequency division multiple access (SC-FDMA) symbols, or the like) in the time domain. The slot may be a time unit based on the numerology.

The slot may include a plurality of mini slots. Each mini slot may include one or more symbols in the time domain. Further, the mini slot may be called a sub-slot. The mini slot may include fewer symbols than a slot. A PDSCH (or PUSCH) transmitted in units of times greater than the mini slot may be called a PDSCH (or PUSCH) mapping type A. A PDSCH (or PUSCH) transmitted using a mini slot may be called a PDSCH (or PUSCH) mapping type B.

All of a radio frame, a sub frame, a slot, a mini slot, and a symbol indicates a time unit for transmitting a signal. As a radio frame, a sub frame, a slot, a mini slot, and a symbol, different designations respectively corresponding to them may be used.

For example, one sub frame may be called a transmission time interval (TTI: Transmission Time Interval), or a plurality of consecutive sub frames may be called TTIs, or one slot or one mini slot may be called a TTI. In other words, at least one of the sub frame and the TTI may be a sub frame (1 ms) in the existing LTE, may be a period shorter than 1 ms (for example, 1 to 13 symbols), or may be referred to as a period longer than 1 ms. A unit representing the TTI may be called slot, a mini slot, or the like instead of the sub frame.

Here, for example, the TTI refers to a minimum time unit of scheduling in radio communication. For example, in the LTE system, the base station performs scheduling of allocating a radio resource (a frequency band width, a transmission power, or the like which can be used in each user equipment) to each user equipment in units of TTIs. The definition of the TTI is not limited thereto.

The TTI may be a transmission time unit such as a channel coded data packet (transport block), a code block, or a codeword, or may be a processing unit such as scheduling or link adaptation. Further, when a TTI is given, a time interval (for example, the number of symbols) in which a transport block, a code block, a codeword, or the like is actually mapped may be shorter than the TTI.

Further, when one slot or one mini slot is called a TTI, one or more TTIs (that is, one or more slots or one or more mini slots) may be a minimum time unit of scheduling. Further, the number of slots (the number of mini slots) constituting the minimum time unit of scheduling may be controlled.

A TTI having a time length of 1 ms may be called a common TTI (TTI in LTE Rel. 8 to 12), a normal TTI, a long TTI, a common sub frame, a normal sub frame, a long sub frame, a slot, or the like. A TTI shorter than the common TTI may be called a reduced TTI, a short TTI, a partial TTI (a partial or fractional TTI), a reduced sub frame, a short sub frame, a mini slot, a sub slot, a slot, or the like.

Further, a long TTI (for example, a common TTI, a sub frame, or the like) may be replaced with a TTI having a time length exceeding 1 ms, and a short TTI (for example, a reduced TTI or the like) may be replaced with a TTI having a TTI length which is less than a TTI length of a long TTI and equal to or more than 1 ms.

The resource block (RB) is a resource allocation unit in the time domain and the frequency region and may include one or more consecutive subcarriers in the frequency region. The number of subcarriers included in an RB may be the same irrespective of a numerology and may be, for example, 12. The number of subcarriers included in an RB may be decided on the basis of a numerology.

Further, a time domain of an RB may include one or more symbols and may be a length of one slot, one mini slot, one sub frame, or one TTI. Each of one TTI, one sub frame, or the like may be constituted by one or more resource blocks.

Further, one or more RBs may be called a physical resource block (PRB), a subcarrier group (SCG), a resource element group (REG), a PRB pair, or the like.

Further, the resource block may be constituted by one or more resource elements (RE). For example, one RE may be a radio resource region of one subcarrier and one symbol.

A bandwidth part (BWP) (which may be called a partial bandwidth) may indicate a subset of consecutive common resource blocks (RBs) for a certain numerology in a certain carrier. Here, a common RB may be specified by an index of an RB based on a common reference point of a carrier. A PRB may be defined in a BWP and numbered in a BWP.

The BWP may include a BWP for UL (UL BWP) and a BWP for DL (DL BWP). In a UE, one or more BWPs may be configured within one carrier.

At least one of configured BWPs may be active, and it may not be assumed that the UE transmits and receives a predetermined signal/channel outside an active BWP. Further, a “cell,” a “carrier,” or the like in the present disclosure may be replaced with a “BWP.”

Structures of the radio frame, the sub frame, slot, the mini slot, and the symbol are merely examples. For example, configurations such as the number of sub frames included in a radio frame, the number of slots per sub frame or radio frame, the number of mini slots included in a slot, the number of symbols and RBs included in a slot or a mini slot, the number of subcarriers included in an RB, the number of symbols in a TTI, a symbol length, a cyclic prefix (CP) length, and the like can be variously changed.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the radio frequency region, the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

Further, “means” in the configuration of each of the above devices may be replaced with “unit,” “circuit,” “device,” or the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as “a”, “an”, and “the” in English are added, in this disclosure, these articles shall include plurality of nouns following these articles.

The terms “determining” and “deciding” used in this specification may include a wide variety of operations. For example, “determining” and “deciding” may include, for example, events in which events such as judging, calculating, computing, processing, deriving, investigating, looking up, search, and inquiry (for example, looking up in a table, a database, or another data structure), or ascertaining are regarded as “determining” or “deciding.” Further, “determining” and “deciding” may include, for example, events in which events such as receiving (for example, receiving information), transmitting (for example, transmitting information), input, output, or accessing (for example, accessing data in a memory) are regarded as “determining” or “deciding.” Further, “determining” and “deciding” may include, for example, events in which events such as resolving, selecting, choosing, establishing, or comparing are regarded as “determining” or “deciding.” In other words, “determining” and “deciding” may include events in which a certain operation is regarded as “determining” or “deciding.” Further, “determining (deciding)” may be replaced with “assuming,” “expecting,” “considering,” or the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 RADIO COMMUNICATION SYSTEM
50 CU
100A, 100B, 100C RADIO COMMUNICATION NODE
110 RADIO TRANSMITTING UNIT
120 RADIO RECEIVING UNIT
130 NW IF UNIT
140 IAB NODE CONNECTING UNIT
150 CONTROL UNIT
161 RADIO TRANSMITTING UNIT
162 RADIO RECEIVING UNIT
170 HIGHER NODE CONNECTING UNIT
180 LOWER NODE CONNECTING UNIT
190 CONTROL UNIT
UE 200
1001 PROCESSOR
1002 MEMORY
1003 STORAGE
1004 COMMUNICATION DEVICE
1005 INPUT DEVICE
1006 OUTPUT DEVICE
1007 BUS

1. A radio communication node comprising:
a higher node connecting unit used for a connection with a higher node;
a lower node connecting unit used for a connection with a lower node; and
a control unit that gives a notification indicating a direction of downlink or uplink in which a radio resource destined for the lower node is used to the higher node or a network.

2. The radio communication node according to claim 1, wherein the control unit gives the notification indicating the used direction for the radio resource which is used in both the downlink and the uplink in the lower node.

3. The radio communication node according to claim 1, wherein the control unit determines a slot which is a notification target in accordance with an interval to notify of the used direction.

4. The radio communication node according to claim 1, wherein the control unit determines the radio resource which is a notification target on the basis of availability of the radio resource.

5. The radio communication node according to claim 1, wherein the control unit gives the notification indicating the used direction for each frequency or each cell.

6. The radio communication node according to claim 2, wherein the control unit determines a slot which is a notification target in accordance with an interval to notify of the used direction.

7. The radio communication node according to claim 2, wherein the control unit determines the radio resource which is a notification target on the basis of availability of the radio resource.

8. The radio communication node according to claim 3, wherein the control unit determines the radio resource which is a notification target on the basis of availability of the radio resource.

9. The radio communication node according to claim 2, wherein the control unit gives the notification indicating the used direction for each frequency or each cell.

10. The radio communication node according to claim 3, wherein the control unit gives the notification indicating the used direction for each frequency or each cell.

11. The radio communication node according to claim 4, wherein the control unit gives the notification indicating the used direction for each frequency or each cell.
